(19) United States
(12) Patent Application Publication
(10) Pub. No.: US 2007/0094124 A1
(43) Pub. Date: Apr. 26, 2007

(54) Technical process to verify transactions made on credit and debit card accounts using wireless devices via AirPay

(76) Inventor: Karl E. Hall, Lewisville, TX (US)

Correspondence Address: Karl E. Hall, Suite 200D, 4341 Lindbergh Dr., Addison, TX, 75001, US

(21) Appl. No.: 11/254,152

(22) Filed: Oct. 20, 2005

(51) Int. Cl. G06Q 40/00

(52) U.S. Cl. 705/38

(57) ABSTRACT

This document presents a technical process for verifying credit and debit card transactions via wireless devices. This process is called AirPay. The AirPay process reduces fraud by giving consumers a tool to verify all transactions made by their credit and debit cards using wireless devices such as their wireless telephones.

### BACKGROUND OF TECHNICAL PROCESS

Credit Card fraud is a major issue hampering consumers, businesses and governments throughout the world. Even with the broad use of credit cards, most consumers still have some anxiety when using their credit cards to purchase goods and services. This anxiety generally stems from the lack of absolute security surrounding the credit card transaction process. In a typical credit card transaction, the consumer's credit card number is generally exposed one or more people. Unauthorized access to this information could result in significant credit card fraud. This business plan presents a solution to this pervasive problem using wireless technology. AirPay is a wireless payment verification startup founded with the purpose of securing and simplifying the merchant transaction process by using a consumer's wireless telephone as a transaction verification tool. AirPay allows customers the ability to safely buy goods and services by attaching their wireless telephone number to their bank and/or credit card account. This connectivity is then used to verify credit card transactions before these transactions are processed.

### BACKGROUND

The U.S. Federal Trade Commission estimates that credit card fraud cost U.S. businesses and the public at least $52 billion in 2004. Unfortunately, even with new fraud detection systems, credit card fraud is increasing every year. AirPay can significantly reduce the amount of global credit card fraud by enabling consumers to take control of their credit card verification process using their wireless telephone. If a consumer's AirPay card number is compromised, an authorization request will be sent to their wireless telephone signaling the consumer to potential fraud.

### INTRODUCTION

Currently, there are many good payment processing systems in the world. These systems are very efficient and generally process payments with extremely low error rates. However, the one common problem with these payment processing systems is that they leave a paper trail of the customer's transaction and credit card number that can be used to commit credit card fraud. AirPay significantly reduces the risk of credit card fraud and gives every consumer with a wireless device such as a wireless phone, PDA or pocket PC the ability to safely buy goods and services by linking their bank and/or credit card accounts to their wireless telephone number for verification. AirPay should also be beneficial for online shoppers since all payments are verified via a wireless telephone prior to the online transaction being processed. AirPay should help increase the adoption of online shopping by giving consumers the comfort of knowing that their online transactions are secure. Customers with traditional credit cards will also be able to use AirPay to secure their credit card transactions prior to their credit card transactions being processed.

With over 1.78 billion wireless users expected by 2007 according to the Yankee Group, enabling wireless devices as a payment verification vehicle creates a large market with exponential growth opportunities. Since credit card processing companies will also be able to license the AirPay wireless verification process and add wireless verification to their traditional credit cards, the demographics of this product is very broad.

Wireless Operating Platforms

The process can be executed using the following operating platforms.

Smartphone;

Palm OS;

Pocket PC;

Microsoft Mobile;

Blackberry;

Symbian; and

Other wireless operating platforms.

This process can be applied to future versions, releases and similar operating platforms.

The process can be executed using the following wireless communications standards.

Global System for Mobile Communications (GSM);

Code Division Multiple Access (CDMA);

Time Division Multiple Access (TDMA); and

Other wireless standards.

This process can be applied to future versions, releases and similar wireless standards.

AirPay Technical Process

AirPay allows consumers the ability to make quick and secure payments from their existing bank and/or credit card accounts. Transactions will be made via to following process. Wireless customers will be issued a AirPay Card with a 16-digit AirPay card number linked to their wireless telephone number and secured client software will be downloaded to their wireless telephone. Customers will then register with AirPay and link the bank account and/or credit card number to their AirPay card. Banks and financial institutions will also be able to issue new AirPay cards or use the AirPay system to verify transactions made with traditional credit cards.

Existing payment processing merchants will be able to scan the AirPay card into the merchant's payment processing system.

AirPay transactions will be identifies by their card numbers as a wireless payment and sent to wireless hub that will anchor a major Payment processing system. The wireless hub will then identify the wireless telephone number associated with the AirPay number, verify that funds are available using funds verification process and send a GSA, CDMA or TDMA encrypted message to the wireless customer's telephone. Traditional credit card holders using AirPay will also be tagged as a AirPay accounts and sent to the wireless hub for verification.

The wireless customer will then get a secured screen on his/her telephone with the amount, a field for a tip, and total payment and a place to enter their password. Essentially, this wireless verification process replaces the physical credit card receipt signing process. The customer completes the secured wireless telephone form and enters his or her password to confirm the transaction. When the customer confirms the order, an encrypted digital signature will be created and sent back to the wireless hub with the time of the transaction, the amount, the merchant number, wireless carrier and other key transaction information. This system may also use Bluetooth wireless networking technology when this technology is available for payment processing.

Once the wireless hub receives the transaction information, the transaction information will be sent back to the payment system for processing.

As mentioned above, traditional credit card companies will also be able to license the AirPay wireless system to verify transactions for their traditional credit card customers. Once a credit card is AirPay secured, all transactions will require wireless verification.

What is claimed is:

1. I claim that “AirPay” is a new and unique process verify credit and debit card transactions using wireless devices.

2. I claim that “AirPay” is a new and unique process to prevent credit and debit card fraud using wireless devices such as wireless telephones.
